(19) United States
(12) Patent Application Publication
(10) Pub. No.: US 2016/0030861 A1
(43) Pub. Date: Feb. 4, 2016

(54) Apparatus and Method for Trapping Sand Present in an Input Fluid Stream

(71) Applicant: Valerus Field Solutions, L.P., Houston, TX (US)

(72) Inventors: Russ Alan Janssen, Victoria, TX (US); Bill Edward Bowers, The Woodlands, TX (US); John Maibry Menard, Jr., Rayne, LA (US)

(21) Appl. No.: 14/450,821

(22) Filed: Aug. 4, 2014

(51) Int. Cl. B01D 21/02; B01D 21/24

(52) U.S. Cl. CPC B01D 21/02; B01D 21/2405; B01D 21/245

(57) ABSTRACT

Separating sand from an input stream comprising a mixture of oil, gas, water and sand. A unitary vessel comprises a spherical portion and a cylindrical portion, the cylindrical portion having a proximal end and a distal end and the spherical portion and cylindrical portion joined at the proximal end of the cylindrical portion. An inlet for the input stream is positioned on the spherical portion of the unitary vessel. A first outlet for an outlet stream comprising oil, water, and natural gas is positioned on the spherical portion of the unitary vessel and below the inlet. A second outlet is positioned adjacent to the distal end of the cylindrical portion of the unitary vessel. Sand can be removed from the unitary vessel via the second outlet.

### TECHNICAL FIELD

The present invention, a hybrid sand trap, generally relates to sand traps and separators used in the oil and gas industry to remove sand and other types of solid particles from pressurized production streams. In particular, the present invention relates to processing streams containing a mixture of sand, water, oil, and natural gas flowing through the trap in order to remove solids from the stream.

### BACKGROUND OF THE INVENTION

Sand is a common operating challenge in the oil and gas industry. Along with gas, water and oil, sand and other particulates can be present in the reservoir and transported along with the fluids to the production system. In addition recent extraction methods such as induced hydraulic fracturing, or “fracking”, purposefully injects sand or other “proppant” materials into the wellbore at high pressure to help prop open fractures induced in the rock formation to allow release of the oil and natural gas present in the rock. When the sand or proppant is produced along with the oil, water, and natural gas, it can cause problems in surface processing infrastructure by clogging equipment and causing erosion and potential failure of piping, valves, meters and machinery. A sand trap seeks to alleviate these problems by removing sand and other solids from the production stream early in the extraction process.

The sand trap accepts an input stream from the wellbore through an inlet port. This stream may consist of oil, water, natural gas, sand, or a combination thereof. Because the interior volume of the separator is much greater than the diameter of the input pipe, upon entering the interior of the separator, the stream experiences a velocity drop sufficient to allow gravity separation of natural gas from the sand and liquid components. The lighter separated natural gas then collects near the top of the separator and is removed through an outlet port.

Once the stream enters into the vessel, it is deflected by a deflector plate. This deflection serves two purposes. First, since the stream may be flowing at high velocity, the deflector redirects the flow, shielding the vessel walls of the trap from sandblasting and thus preserving its longevity. Deflectors and baffles also help break the stream's momentum and direct it to the sides of the separator, reducing flow velocity and turbulence in the stream. Gravity then forces the liquid stream with entrained solids toward the bottom of the vessel, where there is further slowing of the stream, allowing gravity to cause the solid particles to settle to the bottom of the sand trap, where they are separated from the liquid stream. The liquid stream, once separated, makes its way to the top of the container and exits through the outlet port. The bottom of the trap generally contains a sand drain where the sand is expelled.

Conventional traps typically take one of two configurations—vertically oriented cylindrical pressure vessels or spherical pressure vessels. One particular benefit of a cylindrical trap is that it allows for a longer vertical distance between the gas and liquid ports and the sand accumulation section in the bottom of the vessel, thus reducing the likelihood that sand is re-entrained in the outlet fluid streams. However, for a given internal volume and operating pressure, cylindrical vessels of practical length, due to their geometry, create large stresses in the vessel walls and must be made from very thick material in order to withstand higher pressure input streams. Cylindrical vessels can be made with thinner vessel walls if their diameter is reduced. However, this requires that their length must also increase in order to contain the same volume, which may be impractical. Spherical separators, with the same internal volume and operating pressure, by contrast, create far lower stresses in the vessel walls and can be constructed from thinner material, and thus can be constructed using less total weight of materials. Yet, because of their shape, they do not allow for the increased vertical distance between fluid and sand outlet ports present in cylindrical traps.

What is needed are methods and apparatuses that can minimize the construction costs of devices to remove sand from the stream while also allowing adequate internal volume and distance between fluid and solids outlets so as to maximize fluid/solid separation.

### SUMMARY OF THE INVENTION

The present invention incorporates a new shape that is an improvement on conventional sand traps. The apparatus of the present invention is a hybrid vessel that incorporates both spherical and cylindrical shapes. This new shape allows for reduced costs of construction and more efficient removal of sand from fluid streams.

One aspect of the present invention provides for an apparatus for separating and removing sand from an input stream. The apparatus includes a unitary vessel with a spherical portion and a cylindrical portion. The cylindrical portion, which has a proximal end and a distal end, joins the spherical portion at the proximal end. The apparatus is oriented so that the cylindrical portion is aligned vertically with the spherical portion on top of the cylindrical portion. In addition, the cylindrical portion provides a support structure with gussets for the hybrid vessel assembly.

By combining a spherical portion with a smaller diameter cylindrical portion, the present invention allows construction of a pressure vessel of sufficient volume, with high design pressure, with more height than the equivalent volume spherical vessel, and with thinner vessel wall than the equivalent volume cylindrical vessel of practical length.

Additionally, this aspect of the present invention includes an inlet positioned at or above the horizontal midplane of the spherical portion of the vessel. The inlet has a proximal end and a distal end. The distal end is located outside the vessel and the proximal end is located inside the vessel. The input stream, which may include sand, oil, water, natural gas or a mixture thereof, arrives at the separator and flows into the vessel through this inlet.

This aspect of the present invention also includes a liquid/gas outlet, through which a mixture of water, natural gas, and oil, once separated from the sand, is recombined and flows out of the separator. The outlet is positioned on the spherical portion of the vessel below the inlet. The liquid/gas outlet has a proximal end and a distal end. The proximal end is located within the interior of the spherical portion and the distal end is located outside the vessel.

This aspect of the present invention further includes a sand accumulator and an outlet positioned adjacent to the distal end of the cylindrical portion of the separator. The sand collects in the cylindrical portion of the invention and eventually leaves the vessel through the sand outlet. The sand outlet has a proximal end located within the interior of the cylindrical portion of the separator and a distal end located outside the separator.

Another aspect of the invention provides a method for separating sand from a mixture of oil, sand, water, and natural gas. The method includes the steps of: 1) introducing an input stream, which is a mixture of oil, water, natural gas, and sand, into the spherical portion of a unitary vessel through an inlet; 2) directing the input stream to impact a deflector positioned within the spherical portion of the unitary vessel; 3) accumulating oil and water in the lower region of the spherical portion of the unitary vessel; 4) accumulating natural gas in the upper region of the spherical portion of the unitary vessel; 5) accumulating sand in the cylindrical portion of the unitary vessel; 6) removing accumulated gas, water, and oil through the liquid/gas outlet; and 7) removing accumulated sand through a sand outlet.

### BRIEF DESCRIPTION OF THE DRAWINGS

FIG. 1 illustrates an external side view of the sand trap apparatus according to an exemplary embodiment of the present invention.

FIG. 2 illustrates an external side view of the sand trap apparatus according to an exemplary embodiment of the present invention.

FIG. 3 illustrates an external front view of the sand trap apparatus according to an exemplary embodiment of the present invention.

FIG. 4 illustrates a view revealing the external and internal features of the sand trap apparatus according to an exemplary embodiment of the present invention.

FIG. 5 illustrates a process for removing sand from an input stream comprised of a mixture of sand, oil, natural gas, and water according to an exemplary embodiment of the present invention.

Many aspects of the invention can be better understood with reference to the above drawings. The elements and features in the drawings are not to scale; emphasis is instead being placed upon clearly illustrating the principles of example embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION OF EXEMPLARY EMBODIMENTS

Exemplary embodiments of the present invention provide an apparatus and method for removing sand from an input stream that may include of a mixture of sand, oil, natural gas, and water.

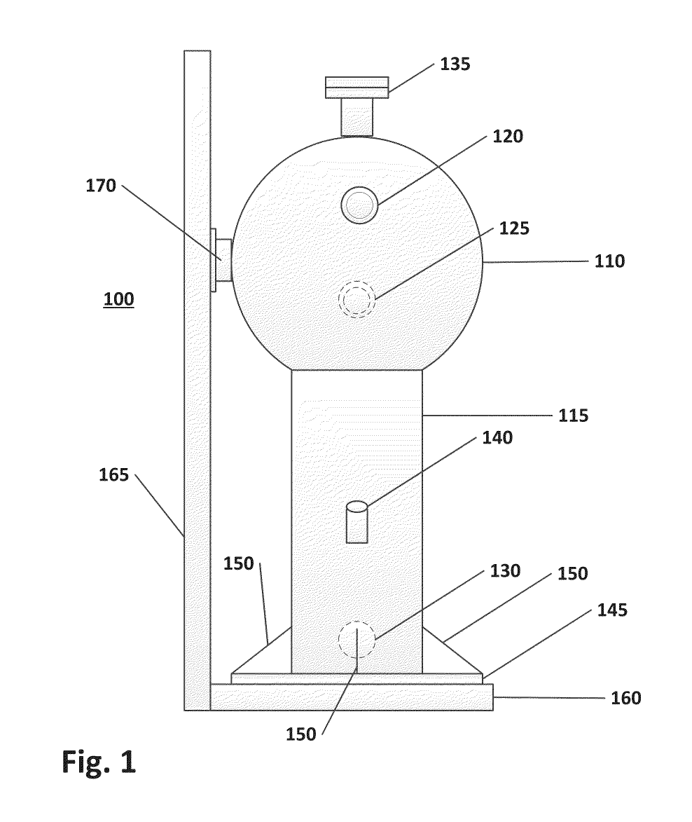

FIG. 1 illustrates an example apparatus for removing sand from an input stream that includes a mixture of sand, oil, natural gas, and water according to certain embodiments. Referring to FIG. 1, a hybrid sand trap apparatus 100 is illustrated from a side view. The apparatus includes an upper spherical portion 110 and a lower cylindrical sand sump portion 115. The spherical portion 110 contains an inlet 120 located at or above the midplane of the spherical portion 110, and an outlet 125 located below the inlet 120. The input stream flows into the inlet 120. Liquid and natural gas flow out from the outlet 125. The spherical portion of the vessel 110 also includes a clean-out port 135. The clean-out port 135 allows the vessel to be cleaned during maintenance. In this exemplary embodiment of the present invention, the input stream includes oil, natural gas, water, and sand. As used here, the term “sand” may include any solid particulate matter. In another embodiment, the input stream may include oil, natural gas, and sand. Still other embodiments may have streams that include oil, water, and sand, etc.

The cylindrical portion of the vessel 115 includes a sand outlet 130 located near the bottom of the vessel. Sand, once removed from the input stream, flows from the vessel though the sand outlet 130. A sump cleanout 140 prevents clogging by allowing the introduction of liquid into the cylindrical portion of the vessel 115 to help expel sand from the unitary vessel 100 though the sand outlet 130. It should be noted that although this exemplary embodiment of the present invention shows the sump cleanout located on the opposite end of the cylindrical portion of the vessel 115 from the sand outlet 130, other embodiments may place it anywhere on the cylindrical portion of the vessel. Gussets 150 help anchor the cylindrical portion of the vessel 115 to the base 145. In this particular embodiment of the present invention, the entire unitary vessel 100 is secured to a bottom support 160 and a back support 165. The back support 165 attaches to the unitary vessel 100 through a support connector 170. The supports may be used to secure the device during operation or for transportation purposes.

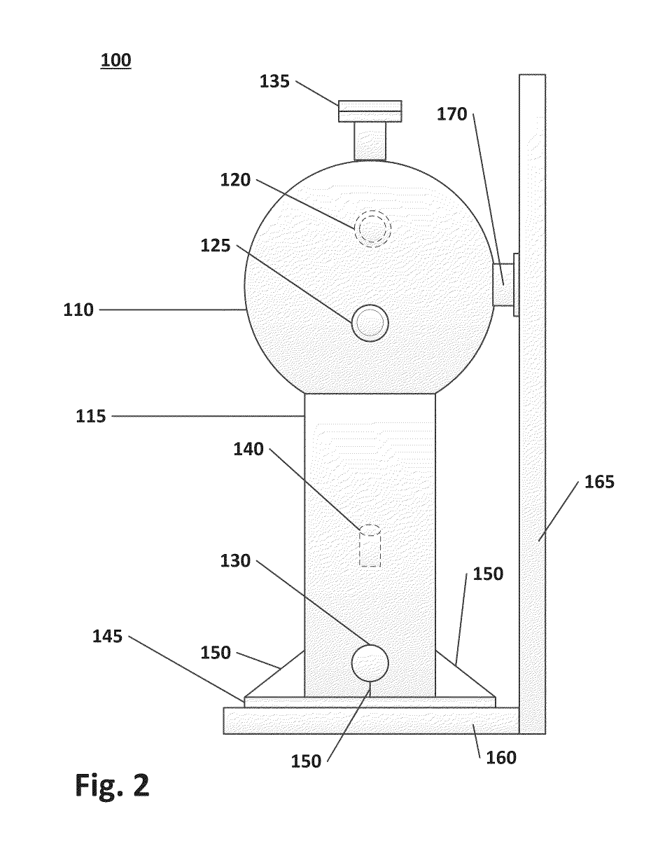

Referring to FIG. 2, the unitary vessel 100 is shown from the opposite side view. From this view, both the outlet 125 and the sand outlet 130 can be seen.

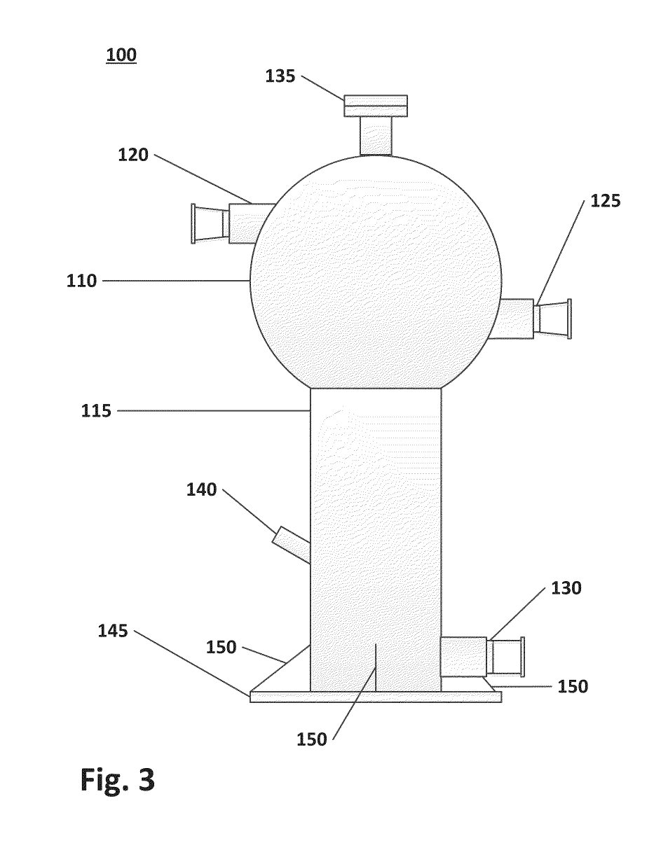

Referring to FIG. 3, the unitary vessel 100 is shown from a front view. From this view, the inlet 120 can be seen to extend from the spherical portion of the vessel 110 and provide a conduit that can be used to introduce the input stream into the spherical portion of the vessel 110. The outlet 125 can also be seen to extend from the unitary vessel 100 and provide a conduit used to remove liquid and natural gas from the spherical portion of the vessel 110. The sand outlet 130 can be seen to extend from the cylindrical portion of the vessel 115 and provide a conduit that can be used to remove sand and liquid from the cylindrical portion of the vessel 115. Finally, the sump cleanout 140 is shown extending from the cylindrical portion of the vessel 115.

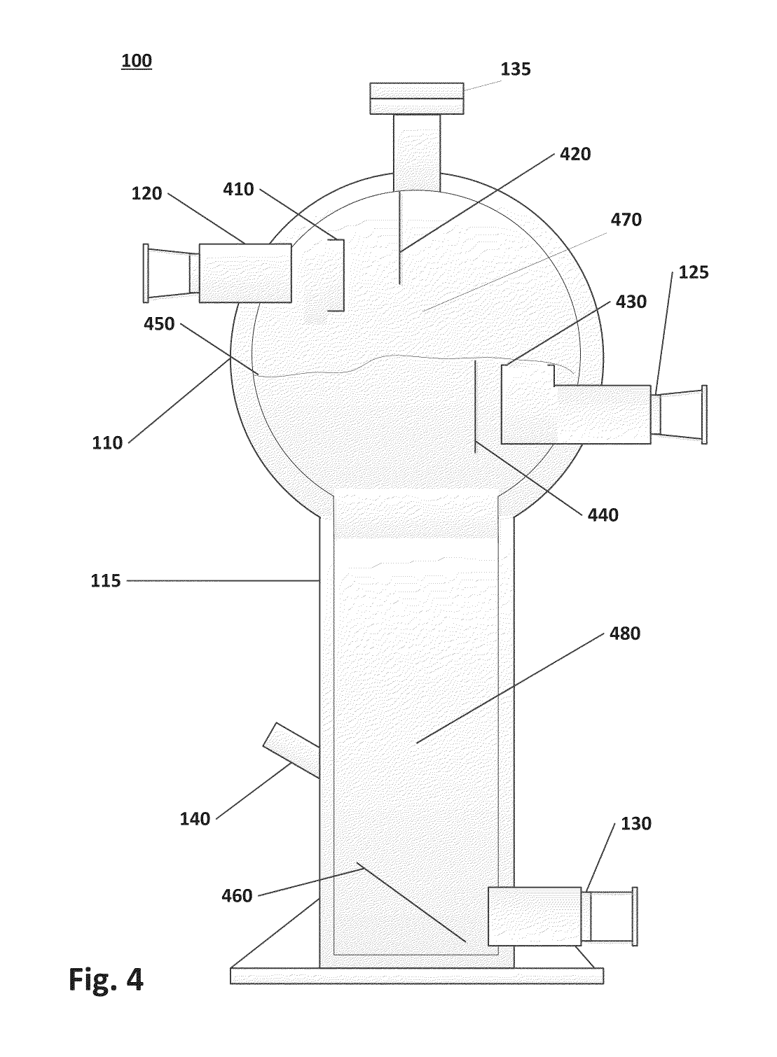

Referring to FIG. 4, the interior of the spherical portion of the vessel 110 contains a deflector 410 located in front of inlet 120. The interior of the spherical portion 110 also contains an inlet spray baffle 420 extending down from the top of the interior wall of the vessel, and an outlet sand baffle 440 located in front of the gas/liquid outlet 125. The proximate end of the gas/liquid outlet 125, located in the interior of the vessel, includes a weir 430. A sand slide 460 is positioned in the bottom of the cylindrical portion of the vessel 115 so that it directs the sand that has accumulated in the sand accumulator section of the cylindrical vessel 480 toward the sand outlet 130, where the sand exits the vessel. In other embodiments, the inlet 120, the gas/liquid outlet 125, and the sand outlet 130 may not contain a proximal end, instead employing simply a hole in the vessel wall.

The deflector 410 serves as a barrier to slow down the input stream, thus encouraging natural gas present in the stream time to separate from the other components. Natural gas will separate from the other components in the stream as the denser components of the stream fall to the bottom of the cylindrical portion of the vessel 115. Because the input stream may arrive in the spherical portion of the unitary vessel 110 under pressure, some of the spray may splash beyond the deflector. The input spray baffle 420 serves to direct any spray-over back to the interior of the vessel and to the walls, thus giving the natural gas more time to separate from the other components of the input stream and preventing sand from mixing with the liquid exiting the gas/liquid outlet 125. Likewise, the outlet sand baffle 440 prevents any sand in the liquid retention section 470 from exiting the outlet 125 and directs the sand toward the interior walls and down toward the cylindrical sand sump portion of the vessel 115. Because the invention has a cylindrical portion 115 in addition to a spherical portion 110, the input stream has greater distance from the sand accumulation section than it would with a spherical shaped vessel alone. A greater distance between inlet and accumulated sand means less sand will be re-entrained in the outlet fluids.

Natural gas is lighter than the liquid and sand present in the input stream. Thus, once separated, the natural gas begins to fill the spherical portion of the vessel 110 while the remaining heavier components of the input stream fall toward the cylindrical portion of the vessel 115. When enough natural gas is present in the spherical portion of the vessel 110, internal pressure forces the natural gas from the vessel through the gas/liquid outlet 125.

Meanwhile, the remaining liquid will begin to fill the cylindrical portion of the vessel 115. Because sand is the heaviest component of the input stream mixture, it will settle and collect in the sand accumulator section of the vessel 480 first while the liquid, containing a mixture of oil and water, will float on top of the sand, eventually entering and filling approximately half of the spherical portion of the vessel 110. The sloped sand slide 460 located at the bottom of the cylindrical portion of the vessel 115 is positioned so that it directs the sand toward the sand outlet 130, where the sand exits the vessel. A sump cleanout 140 aids the sand expulsion by allowing liquid to be introduced into the cylindrical portion of the vessel 115. Liquid introduced into the vessel from the sump cleanout 140 helps direct the sand down the sand slide 460 and out of the sand outlet 130, thus preventing clogging of the sand outlet 130.

As the vessel fills, the liquid level will begin to rise into the spherical portion of the vessel 110. Once the liquid rises to the level of the weir 430, it will flow over the weir 430 and out through the outlet 125. Any natural gas present and exiting the spherical portion of the vessel 110 through the outlet 125 will also aid in removing the liquid by dragging it over the weir 430 and out through the outlet 125. The weir 430 allows the liquid to flow into the outlet but not completely fill the opening, thus allowing natural gas to flow out of the outlet 125 along with the liquid.

Combining the spherical portion of the vessel 110 with the smaller diameter cylindrical portion 115 provides sufficient volume while at the same time offering a greater vertical distance between the gas/liquid outlet 125 and the sand accumulator section of the vessel 480 than does a conventional sand trap with equivalent volume spherical vessel. The greater vertical distance reduces the likelihood that sand is re-entrained in the outlet fluid streams. Furthermore, because the input stream arrives into the spherical portion of the vessel 110, and spherical vessels, due their geometry create lower stress in the vessel walls, the vessel can be constructed with thinner material than an equivalent volume cylindrical vessel while also being able to withstand higher pressure input streams. This allows the vessel to be constructed using less total weight of materials.

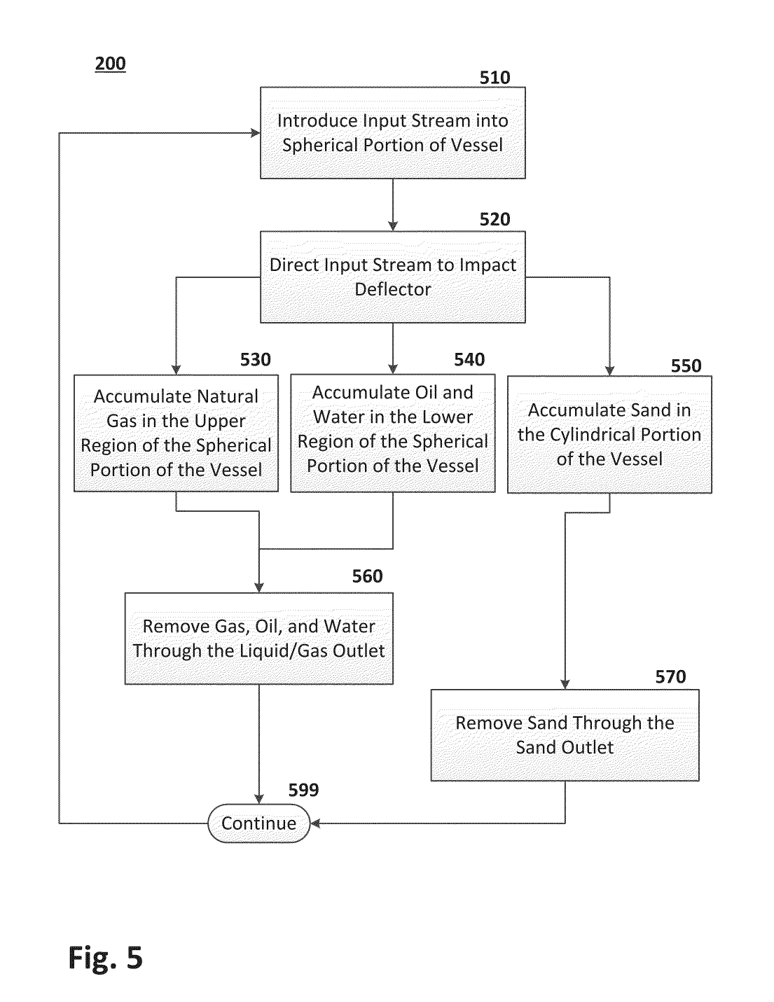

FIG. 5 illustrates an embodiment of a method of removing sand from an input stream containing a mixture of sand, water, oil, and natural gas. In another embodiment, the input stream may include oil, natural gas, and sand. Still other embodiments may have streams that include oil, water, and sand, etc. Referring to FIG. 5, at step 510, an input stream containing a mixture of sand, water, oil, and natural gas is introduced into the spherical portion of the vessel 110.

At step 520, the input stream is directed to a deflector 410 which deflects the stream to the internal sides of the vessel. Deflecting serves multiple purposes. First, it slows down the velocity of the input stream allowing lighter natural gas time to separate from the other components present in the input stream. Additionally, because the water is under pressure, the deflector shields the internal walls from an initial sand blast thus prolonging the life of the invention. Lastly, by directing the input stream toward the interior walls, the stream is made to slow down even more as it must now flow down the side of the vessel instead of simply falling to the bottom. This gives the natural gas even more time to separate from the other components present in the input stream.

Steps 530, 540, and 550 may occur simultaneously or successively.

At step 530, natural gas separates from the other components of the input stream, and because it is lighter than the liquid, accumulates in the upper region of the spherical portion of the vessel 110.

At step 550, the remaining liquid fills the vessel and as it does, the sand, being the heaviest component of the liquid, will begin to separate from the other components in the liquid and accumulate in the lower region of the cylindrical portion of the vessel 115.

At step 540, the remaining oil and water mixture, now floating on top of the sand will accumulate in the lower region of the spherical portion of the vessel 110.

At step 560, as the liquid fills the spherical portion of the vessel, it eventually flows over the weir 430 recombines with the gas, and exits the vessel through the outlet 125.

At step 570, sand is removed through the sand outlet.

In view of the foregoing, it will be understood that an exemplary embodiment comprises a mechanism for separating sand from an input stream comprising a mixture of oil, gas, water and sand. A unitary vessel comprises a spherical portion and a cylindrical portion, the cylindrical portion having a proximal end and a distal end and the spherical portion and cylindrical portion joined at the proximal end of the cylindrical portion. An inlet for the input stream is positioned on the spherical portion of the unitary vessel. A first outlet for an outlet stream comprising oil, water, and natural gas is positioned on the spherical portion of the unitary vessel and below the inlet. A second outlet is positioned adjacent to the distal end of the cylindrical portion of the unitary vessel. The second outlet provides an outlet for sand collected within the cylindrical portion of the unitary vessel. Sand trapped by the cylindrical portion of the unitary vessel can be removed from the unitary vessel via the second outlet. A deflector can be positioned within the spherical portion such that at least a portion of the input stream contacts the deflector. A weir can be positioned within the spherical vessel and adjacent to the first outlet, wherein the weir is positioned to allow both liquid and natural gas to exit the unitary vessel though the first outlet. A sand slide can be located within the cylindrical section of the unitary vessel, wherein the sand slide is oriented to direct sand to the second outlet.

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow. Accordingly, the specification and drawings are to be regarded in an illustrative rather than a restrictive sense.

What is claimed:

1. An apparatus for separating sand from an input stream comprising:
a unitary vessel comprising a spherical portion and a cylindrical portion, wherein the cylindrical portion comprises a proximal end and a distal end and wherein the spherical portion and cylindrical portion are joined at the proximal end of the cylindrical portion;
an inlet for the input stream, positioned on the spherical portion of the unitary vessel, wherein the input stream comprises a mixture of sand, oil, water, and natural gas, the inlet comprising a proximal end located within the interior of the spherical portion of the unitary vessel and a distal end located outside the unitary vessel;
a liquid/gas outlet for an outlet stream comprising oil, water, and natural gas, positioned on the spherical portion of the unitary vessel and below the inlet, the liquid/gas outlet comprising a proximal end located within the interior of the spherical portion of the unitary vessel and a distal end located outside the unitary vessel; and
a sand outlet positioned adjacent to the distal end of the cylindrical portion of the unitary vessel, the sand outlet comprising a proximal end located within the interior of the cylindrical portion of the unitary vessel and a distal end located outside the unitary vessel.

2. The apparatus of claim 1 further comprising a deflector adjacent to the proximal end of the inlet, wherein the deflector is positioned such that at least a portion of the input stream contacts the deflector.

3. The apparatus of claim 1 further comprising a weir adjacent to the proximal end of the liquid/gas outlet, wherein the weir is positioned to allow both liquid and natural gas to exit the unitary vessel though the liquid/gas outlet.

4. The apparatus of claim 1 further comprising a sand slide located adjacent to the distal end of the cylindrical section of the vessel, wherein the sand slide is oriented to direct sand to the proximal end of the sand outlet.

5. The apparatus of claim 1 further comprising an inlet spray baffle substantially located in the spherical portion of the unitary vessel above the horizontal midplane of the spherical portion of the unitary vessel.

6. The apparatus of claim 1 further comprising an outlet sand baffle substantially located in the spherical portion of the unitary vessel below the horizontal midplane of the spherical portion of the unitary vessel.

7. The apparatus of claim 1 further comprising a sand cleanout positioned at the cylindrical portion of the vessel, wherein the sand cleanout comprises an inlet for liquid to flush sand out of the sand outlet.

8. The apparatus of claim 1 further comprising a vessel cleanout.

9. The apparatus of claim 8 wherein the vessel cleanout is positioned adjacent to the top of the spherical portion of the unitary vessel.

10. The apparatus of claim 1 wherein the input fluid stream flows at various operating pressures.

11. A method for separating sand from an input stream comprising the steps of:
introducing the input stream into a spherical portion of a unitary vessel through an inlet, wherein the input stream comprises oil, water, natural gas, and sand;
directing the input stream to impact a deflector positioned within the spherical portion of the unitary vessel;
accumulating oil and water in the lower region of the spherical portion of the unitary vessel;
accumulating natural gas in the upper region of the spherical portion of the unitary vessel;
accumulating sand in the cylindrical portion of the unitary vessel;
removing accumulated natural gas, oil, and water through a liquid/gas outlet, wherein the liquid/gas outlet is positioned on the spherical portion of the unitary vessel below the inlet; and
removing accumulated sand through a sand outlet, wherein the sand outlet is positioned adjacent to the distal end of the cylindrical portion of the unitary vessel.

12. The method of claim 11 wherein the step of removing accumulated natural gas, oil, and water through a liquid/gas outlet further comprises removing the accumulated natural gas, oil, and water over a weir.

13. The method of claim 11 wherein the step of removing accumulated sand through a sand outlet further comprises directing accumulated sand to the sand outlet by a sand slide.

14. The method of claim 11 wherein the step of removing accumulated sand through a sand outlet further comprises introducing water into a sand cleanout to promote removing the accumulated sand through the sand outlet.

15. An apparatus for separating sand from an input stream comprising:
a unitary vessel comprising a spherical portion and a cylindrical portion, the cylindrical portion comprising a proximal end and a distal end, and the spherical portion and cylindrical portion joined at the proximal end of the cylindrical portion;
an inlet for the input stream, positioned on the spherical portion of the unitary vessel, wherein the input stream comprises a mixture of sand, oil, water, and natural gas;
a first outlet, positioned on the spherical portion of the unitary vessel and below the inlet, providing an outlet for an outlet stream comprising oil, water, and natural gas; and
a second outlet, positioned adjacent to the distal end of the cylindrical portion of the unitary vessel, providing an outlet for sand collected within the cylindrical portion of the unitary vessel.

16. The apparatus of claim 15 further comprising a deflector positioned within the spherical portion such that at least a portion of the input stream contacts the deflector.

17. The apparatus of claim 15 further comprising a weir positioned within the spherical vessel and adjacent to the first outlet, wherein the weir is positioned to allow both liquid and natural gas to exit the unitary vessel though the first outlet.

18. The apparatus of claim 15 further comprising a sand slide located within the cylindrical section of the vessel, wherein the sand slide is oriented to direct sand to the second outlet.

19. The apparatus of claim 15 further comprising an inlet spray baffle substantially located in the spherical portion of the unitary vessel above the horizontal midplane of the spherical portion of the unitary vessel.

20. The apparatus of claim 15 further comprising an outlet sand baffle substantially located in the spherical portion of the unitary vessel below the horizontal midplane of the spherical portion of the unitary vessel.
